(19) United States
(12) Patent Application Publication
(10) Pub. No.: US 2017/0219678 A1
(43) Pub. Date: Aug. 3, 2017

(54) POSITIONING DETECTION METHOD AND APPARATUS, AND COMPUTER STORAGE MEDIUM

(71) Applicant: BAIDU ONLINE NETWORK TECHNOLOGY (BEIJING) CO., LTD., Beijing (CN)

(72) Inventor: Suqi LIN, Beijing (CN)

(21) Appl. No.: 15/119,316

(22) PCT Filed: Dec. 2, 2014
(86) PCT No.: PCT/CN2014/092745

§ 371 Date: Aug. 16, 2016

(30) Foreign Application Priority Data
Feb. 18, 2014 (CN) 201410054240.X

(51) Int. Cl. G01S 5/02; H04W 64/00

(52) U.S. Cl. CPC G01S 5/021; H04W 64/003

(57) ABSTRACT

The present invention provides a positioning detection method and apparatus, and a computer storage medium. The method includes: acquiring a positioning signal of any positioning request; obtaining, by using an existing positioning service system, location information corresponding to the positioning signal of the positioning request; obtaining, from a preset bad positioning result database, location information of a bad positioning result corresponding to the positioning signal of the positioning request, where the bad positioning result database is used to store the positioning signal of the positioning request, and the location information of the bad positioning result corresponding to the positioning signal of the positioning request; determining whether the obtained location information is close to the obtained location information of the bad positioning result; and if the obtained location information is close to the obtained location information of the bad positioning result, determining that the obtained location information is the bad positioning result.

This application claims priority to Chinese Patent Application No. 201410054240.X, filed on Feb. 18, 2014 and entitled “POSITIONING DETECTION METHOD AND APPARATUS”.

### BACKGROUND

Technical Field

This application relates to a positioning detection method and apparatus, and a computer storage medium, and in particular, to a technology for automatically detecting a bad positioning result in a positioning service system.

Related Art

As wireless Internet develops rapidly and smart phone technologies update constantly, positioning services of mobile phones emerge. By using positioning services of mobile phones, users can not only conveniently learn of a current geographical location and know information about various nearby places in time, but also can position other mobile phone users. However, some bad positioning results (Badcase, that is, location information acquired by a user by using a positioning service is inaccurate, or deviation of acquired location information from an actual location of the user exceeds an allowed range) that appear in a positioning service process of a mobile phone affect positioning experience of a user about a positioning service of the mobile phone, and directly cause that a positioning result of a positioning request of the mobile phone is inaccurate. Therefore, how to effectively detect bad positioning results that appear in a positioning service process of a mobile phone, and how to determine reasons of the bad positioning results are critical to repair of a positioning service system.

### SUMMARY

An objective of the present invention is to provide a positioning detection method and apparatus, and a computer storage medium, to automatically detect a bad positioning result in a positioning service process of a mobile phone.

According to one aspect of the present invention, a positioning detection method is provided, where the method includes: acquiring a positioning signal of any positioning request; obtaining, by using an existing positioning service system, location information corresponding to the positioning signal of the positioning request; obtaining, from a preset bad positioning result database, location information of a bad positioning result corresponding to the positioning signal of the positioning request, where the bad positioning result database is used to store the positioning signal of the positioning request, and the location information of the bad positioning result corresponding to the positioning signal of the positioning request; determining whether the obtained location information is close to the obtained location information of the bad positioning result; and if the obtained location information is close to the obtained location information of the bad positioning result, determining that the obtained location information is the bad positioning result.

Preferably, before the obtaining, from a preset bad positioning result database, location information of a bad positioning result corresponding to the positioning signal of the positioning request, the method further includes: updating the bad positioning result database.

Preferably, a specific step of updating the bad positioning result database is: mining a bad positioning result from a positioning log generated by the positioning service system; and updating the bad positioning result database according to the mined bad positioning result.

Preferably, the method further includes: determining a reason why the obtained location information is the bad positioning result.

Preferably, the positioning signal of the positioning request is a base-station positioning signal.

Preferably, a specific step of determining a reason why the obtained location information is the bad positioning result is: obtaining, from a base-station information database of the positioning service system, base-station location information corresponding to the base-station positioning signal of the positioning request; determining a distance between an acquired base-station location and an actual location of the positioning request; and if the determined distance is less than a first preset distance, determining that the acquired base-station location does not deviate relative to the actual location of the positioning request, and determining that the reason why the obtained location information is the bad positioning result is that a manner in which the positioning service system determines, according to acquired base-station location information, the base-station location information corresponding to the base-station positioning signal of the positioning request is wrong; or if the determined distance is not less than the first preset distance, determining that the acquired base-station location deviates relative to the actual location of the positioning request, and determining that the reason why the obtained location information is the bad positioning result is that the acquired base-station location deviates relative to the actual location of the positioning request.

Preferably, a specific step of determining that the reason why the obtained location information is the bad positioning result is that the acquired base-station location deviates relative to the actual location of the positioning request is: obtaining, from the base-station information database of the positioning service system, a confidence range of the base-station location information corresponding to the base-station positioning signal of the positioning request; and if the actual location of the positioning request is within the acquired confidence range, determines that data of the acquired confidence range is correct, and determines that the reason why the obtained location information is the bad positioning result is that a manner in which the base-station information database of the positioning service system creates the base-station location information corresponding to the base-station positioning signal of the positioning request is wrong; or if the actual location of the positioning request is not within the acquired confidence range, determines that data of the acquired confidence range is incorrect, and determines that the reason why the obtained location information is the bad positioning result is that all location data of the base-station information database of the positioning service system is wrong.

Preferably, the positioning signal of the positioning request is a Wi-Fi positioning signal.

Preferably, a specific step of determining a reason why the obtained location information is the bad positioning result is: obtaining, from a Wi-Fi hotspot information database of the positioning service system, Wi-Fi hotspot location information corresponding to the Wi-Fi positioning signal of the positioning request; determining a distance between an acquired Wi-Fi hotspot location and an actual location of the positioning request; and if the determined distance is less than a second preset distance, determining that the acquired Wi-Fi hotspot location does not deviate relative to the actual location of the positioning request, and determining that the reason why the obtained location information is the bad positioning result is that a manner in which the positioning service system determines, according to acquired Wi-Fi hotspot location information, the Wi-Fi hotspot location information corresponding to the Wi-Fi positioning signal of the positioning request is wrong; or if the determined distance is not less than second first preset distance, determining that the acquired Wi-Fi hotspot location deviates relative to the actual location of the positioning request, and determining that the reason why the obtained location information is the bad positioning result is that the acquired Wi-Fi hotspot location deviates relative to the actual location of the positioning request.

Preferably, a specific step of determining that the reason why the obtained location information is the bad positioning result is that the acquired Wi-Fi hotspot location deviates relative to the actual location of the positioning request is: obtaining, from the Wi-Fi hotspot information database of the positioning service system, a confidence range of the Wi-Fi hotspot location information corresponding to the Wi-Fi positioning signal of the positioning request; and if the actual location of the positioning request is within the acquired confidence range, determines that data of the acquired confidence range is correct, and determines that the reason why the obtained location information is the bad positioning result is that a manner in which the Wi-Fi hotspot information database of the positioning service system creates the Wi-Fi hotspot location information corresponding to the Wi-Fi positioning signal of the positioning request is wrong; or if the actual location of the positioning request is not within the acquired confidence range, determines that data of the acquired confidence range is incorrect, and determines that the reason why the obtained location information is the bad positioning result is that all location data of the Wi-Fi hotspot information database of the positioning service system is wrong.

According to another aspect of the present invention, a positioning detection apparatus is provided, where the apparatus includes: a positioning request acquiring unit, configured to acquire a positioning signal of any positioning request; an original positioning service unit, configured to obtain, by using an existing positioning service system, location information corresponding to the positioning signal of the positioning request; a bad positioning unit, configured to obtain, from a preset bad positioning result database, location information of a bad positioning result corresponding to the positioning signal of the positioning request, where the bad positioning result database is used to store the positioning signal of the positioning request, and the location information of the bad positioning result corresponding to the positioning signal of the positioning request; a result comparison unit, configured to determine whether the obtained location information is close to the obtained location information of the bad positioning result; and a bad positioning determining unit, configured to: if the obtained location information is close to the obtained location information of the bad positioning result, determining that the obtained location information is the bad positioning result.

Preferably, the apparatus further includes: a bad positioning update unit, configured to update the bad positioning result database before the location information of the bad positioning result corresponding to the positioning signal of the positioning request is obtained from the preset bad positioning result database.

Preferably, the bad positioning update unit includes: a bad positioning mining subunit, configured to mine a bad positioning result from a positioning log generated by the positioning service system; and a bad positioning update subunit, configured to update the bad positioning result database according to the mined bad positioning result.

Preferably, the apparatus further includes: a bad positioning analyzing unit, configured to determine a reason why the obtained location information is the bad positioning result.

Preferably, the positioning signal of the positioning request is a base-station positioning signal.

Preferably, the bad positioning analyzing unit includes: a base-station information acquiring subunit, configured to obtain, from a base-station information database of the positioning service system, base-station location information corresponding to the base-station positioning signal of the positioning request; a first distance determining subunit, configured to determine a distance between an acquired base-station location and an actual location of the positioning request; and a first analyzing subunit, configured to: if the determined distance is less than a first preset distance, determine that the obtained base-station location does not deviate relative to the actual location of the positioning request, and determine that the reason why the obtained location information is the bad positioning result is that a manner in which the positioning service system determines, according to acquired base-station location information, the base-station location information corresponding to the base-station positioning signal of the positioning request is wrong; or a second analyzing subunit, configured to: if the determined distance is not less than the first preset distance, determine that the obtained base-station location deviates relative to the actual location of the positioning request, and determine that the reason why the obtained location information is the bad positioning result is that the base-station location obtained by the base-station information acquiring subunit deviates relative to the actual location of the positioning request.

Preferably, the second analyzing subunit obtains, from the base-station information database of the positioning service system, a confidence range of the base-station location information corresponding to the base-station positioning signal of the positioning request; and if the actual location of the positioning request is within the acquired confidence range, determines that data of the acquired confidence range is correct, and determines that the reason why the obtained location information is the bad positioning result is that a manner in which the base-station information database of the positioning service system creates the base-station location information corresponding to the base-station positioning signal of the positioning request is wrong; or if the actual location of the positioning request is not within the acquired confidence range, determines that data of the acquired confidence range is incorrect, and determines that the reason why the obtained location information is the bad positioning result is that all location data of the base-station information database of the positioning service system is wrong.

Preferably, the positioning signal of the positioning request is a Wi-Fi positioning signal.

Preferably, the bad positioning analyzing unit includes: a Wi-Fi information acquiring subunit, configured to obtain, from a Wi-Fi hotspot information database of the positioning service system, Wi-Fi hotspot location information corresponding to the Wi-Fi positioning signal of the positioning request; a second distance determining subunit, configured to determine a distance between an obtained Wi-Fi hotspot location and an actual location of the positioning request; and a third analyzing subunit, configured to: if the determined distance is less than a second preset distance, determine that the obtained Wi-Fi hotspot location does not deviate relative to the actual location of the positioning request, and determine that the reason why the obtained location information is the bad positioning result is that a manner in which the positioning service system determines, according to acquired Wi-Fi hotspot location information, the Wi-Fi hotspot location information corresponding to the Wi-Fi positioning signal of the positioning request is wrong; or a fourth analyzing subunit, configured to: if the determined distance is not less than the first preset distance, determine that the obtained Wi-Fi hotspot location deviates relative to the actual location of the positioning request, and determine that the reason why the obtained location information is the bad positioning result is that the obtained Wi-Fi hotspot location deviates relative to the actual location of the positioning request.

Preferably, the fourth analyzing subunit obtains, from a Wi-Fi hotspot information database of the positioning service system, a confidence range of Wi-Fi hotspot location information corresponding to the Wi-Fi positioning signal of the positioning request; and if the actual location of the positioning request is within the acquired confidence range, determines that data of the acquired confidence range is correct, and determines that the reason why the obtained location information is the bad positioning result is that a manner in which the Wi-Fi hotspot information database of the positioning service system creates the Wi-Fi hotspot location information corresponding to the Wi-Fi positioning signal of the positioning request is wrong; or if the actual location of the positioning request is not within the acquired confidence range, determines that data of the acquired confidence range is incorrect, and determines that the reason why the obtained location information is the bad positioning result is that all location data of the Wi-Fi hotspot information database of the positioning service system is wrong.

Compared with the prior art, the present invention has the following advantages:

In the present invention, a bad positioning result can be automatically detected in a positioning service process of a mobile phone, and moreover, manual analyzing of a bad positioning result is effectively avoided, which effectively improves detection and analyzing efficiency of a bad positioning result.

In addition, in the present invention, a reason of a bad positioning result can be determined, and online panoramic collection of a bad positioning result can be implemented, thereby expanding estimation influence of a bad positioning result in a positioning service process, and providing a reasonable and reliable basis for repairing a positioning service system.

### BRIEF DESCRIPTION OF THE DRAWINGS

FIG. 1 is a flowchart of a positioning detection method according to an exemplary embodiment of the present invention; and

FIG. 2 is a structural block diagram of a positioning detection apparatus according to an exemplary embodiment of the present invention.

### DETAILED DESCRIPTION

To make the objectives, the technical solutions, and advantages of the present invention clearer, the present invention is described in detail below with reference to accompanying drawings and specific embodiments.

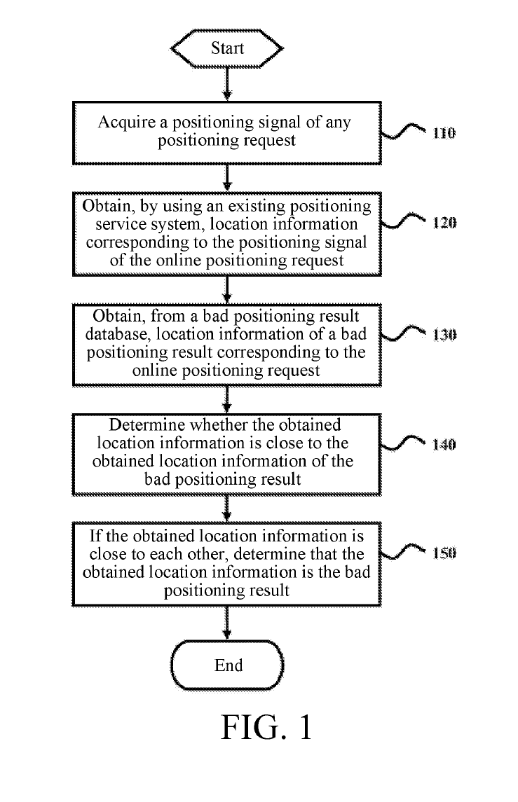

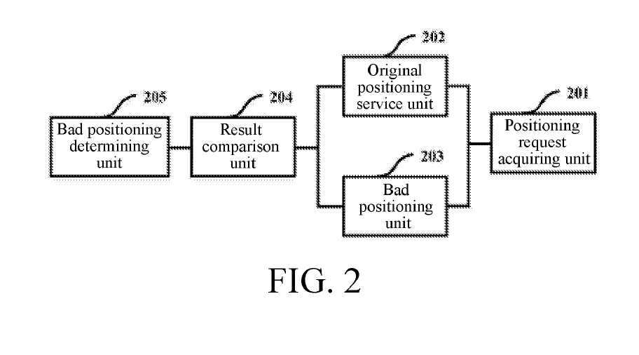

FIG. 1 is a flowchart of a preferred embodiment of a positioning detection method according to the present invention. A positioning detection apparatus shown in FIG. 2 may be configured to implement the method in FIG. 1.

Referring to FIG. 1, step 110: The apparatus acquires a positioning signal of any positioning request.

The positioning request may be an online positioning request or may be an offline positioning request, which is not limited in the present invention.

Step 120: The apparatus obtains, by using an existing positioning service system, location information corresponding to the positioning signal of the positioning request.

Step 130: The apparatus obtains, from a preset bad positioning result (that is, Badcase) database, location information of a bad positioning result (that is, Badcase) corresponding to the positioning signal of the positioning request, where the bad positioning result (that is, Badcase) database is used to store the positioning signal of the positioning request, and the location information of the bad positioning result (that is, Badcase) corresponding to the positioning signal of the positioning request.

Step 140: The apparatus determines whether the obtained location information is close to the obtained location information of the bad positioning result (that is, Badcase).

Step 150: If the obtained location information is close to the obtained location information of the bad positioning result (that is, Badcase), the apparatus determines that the obtained location information is the bad positioning result (that is, Badcase).

Because a user constantly generates a new positioning request everyday, a bad positioning result (that is, Badcase) needs to be mined from newly added log data of the user, so that the bad positioning result (that is, Badcase) database can accurately reflect a newly added bad positioning result (that is, Badcase) of the positioning service system in time. According to an optional embodiment of the present invention, in the embodiment shown in FIG. 1, the method further includes: the apparatus updates the bad positioning result (that is, Badcase) database before obtaining, from the preset bad positioning result (that is, Badcase) database, the location information of the bad positioning result (that is, Badcase) corresponding to the positioning signal of the positioning request.

According to an exemplary embodiment of the present invention, a specific step of updating the bad positioning result (that is, Badcase) database by the apparatus is: the apparatus mines a bad positioning result (that is, Badcase) from a positioning log generated by the positioning service system; and updates the bad positioning result (that is, Badcase) database according to the mined bad positioning result (that is, Badcase). During specific implementation, the apparatus may mine and gather, offline by using a hadoop (that is, a distributed software framework) platform, bad positioning results (that is, Badcase) from a positioning log generated by the existing positioning service system everyday.

A specific step of mining, by the apparatus, a bad positioning result (that is, Badcase) from a positioning log generated by the positioning service system is: the apparatus acquires, from the positioning log generated by the positioning service system, a positioning signal of any positioning request and location information that is calculated by the positioning service system according to the positioning signal of the positioning request, determines a distance between a calculated location and an actual location of the positioning request, and if the determined distance is greater than a given threshold, determines that the calculated location information is a bad positioning result (that is, Badcase).

The actual location of the positioning request may be already known, or may be acquired by using GPS (Global Positioning System, global positioning system) information carried in a positioning request of a mobile phone, which is not limited in the present invention.

In addition, it should be further noted that the foregoing manner of updating the bad positioning result (that is, Badcase) database is only for exemplary purpose, the present invention is not limited thereto, and all other manners may be applied to the present invention as long as these manners help to obtain latest data of a bad positioning result (that is, Badcase).

According to an exemplary embodiment of the present invention in which a positioning request of a mobile phone carries GPS information, if a user starts a GPS positioning service on the mobile phone, the positioning request obtained by the apparatus not only includes the positioning signal of the positioning request, but also includes GPS information of the positioning request, that is, the actual location of the positioning request (gps_x, gps_y). The apparatus obtains, by using the existing positioning service system, location information (resx, resy) corresponding to positioning information of the positioning request, calculates a distance between the obtained location (resx, resy) and the actual location of the positioning request (gps_x, gps_y), if the calculated distance is greater than a given threshold, and determines that the calculated location information is a bad positioning result (that is, Badcase), that is, the location information (resx, resy) acquired by using the existing positioning service system deviates from the actual location of the positioning request (gps_x, gps_y); and the apparatus stores the location information in the bad positioning result (that is, Badcase) database as a bad positioning result (that is, Badcase). During specific implementation, the apparatus may store, in the bad positioning result (that is, Badcase) database, a correspondence between the obtained entire positioning request and the location information acquired by using the existing positioning service system. A specific data format is as follows:

Request_context,resx, resy.

Request_context is content of the positioning request of the mobile phone, and the content of the request may be base-station positioning information, or may be Wi-Fi positioning information, or may be a combination thereof, which is not limited in the present invention either.

To provide a reasonable and reliable basis for repairing the positioning service system, according to another optional embodiment of the present invention, in the embodiment shown in FIG. 1, the method further includes: the apparatus determines a reason why the acquired location information is the bad positioning result (that is, Badcase).

Specifically, according to an exemplary embodiment of the present invention in which the positioning signal of the positioning request is a base-station positioning signal, a specific step of determining, by the apparatus, a reason why the acquired location information is the bad positioning result (that is, Badcase) is: the apparatus obtains, from the base-station information database of the positioning service system, base-station location information corresponding to the base-station positioning signal of the positioning request; determines a distance between an acquired base-station location and the actual location of the positioning request; if the determined distance is less than a first preset distance, determines that the acquired base-station location does not deviate relative to the actual location of the positioning request, and determines that the reason why the acquired location information is the bad positioning result (that is, Badcase) is that a manner in which the positioning service system determines, according to acquired base-station location information, the base-station location information corresponding to the base-station positioning signal of the positioning request is wrong; or if the determined distance is not less than the first preset distance, determines that the acquired base-station location deviates relative to the actual location of the positioning request, and determines that the reason why the acquired location information is the bad positioning result (that is, Badcase) is that the acquired base-station location deviates relative to the actual location of the positioning request.

More specifically, according to the exemplary embodiment of the present invention in which the positioning signal of the positioning request is the base-station positioning signal, a specific step of determining, by the apparatus, that the reason why the acquired location information is the bad positioning result (that is, Badcase) is that the acquired base-station location deviates relative to the actual location of the positioning request is: the apparatus obtains, from the base-station information database of the positioning service system, a confidence range of the base-station location information corresponding to the base-station positioning signal of the positioning request; and if the actual location of the positioning request is within the acquired confidence range, determines that data of the acquired confidence range is correct, and determines that the reason why the acquired location information is the bad positioning result (that is, Badcase) is that a manner in which the base-station information database of the positioning service system creates the base-station location information corresponding to the base-station positioning signal of the positioning request is wrong; or if the actual location of the positioning request is not within the acquired confidence range, determines that data of the acquired confidence range is incorrect, and determines that the reason why the acquired location information is the bad positioning result (that is, Badcase) is that all location data of the base-station information database of the positioning service system is wrong.

Specifically, according to an exemplary embodiment of the present invention in which the positioning signal of the positioning request is a Wi-Fi positioning signal, a specific step of determining, by the apparatus, a reason why the acquired location information is the bad positioning result (that is, Badcase) is: the apparatus obtains, from a Wi-Fi hotspot information database of the positioning service system, Wi-Fi hotspot location information corresponding to the Wi-Fi positioning signal of the positioning request; determines a distance between an acquired Wi-Fi hotspot location and the actual location of the positioning request; if the determined distance is less than a second preset distance, determines that the acquired Wi-Fi hotspot location does not deviate relative to the actual location of the positioning request, and determines that the reason why the acquired location information is the bad positioning result (that is, Badcase) is that a manner in which the positioning service system determines, according to acquired Wi-Fi hotspot location information, the Wi-Fi hotspot location information corresponding to the Wi-Fi positioning signal of the positioning request is wrong; or if the determined distance is not less than the second preset distance, determines that the acquired Wi-Fi hotspot location deviates relative to the actual location of the positioning request, and determines that the reason why the acquired location information is the bad positioning result (that is, Badcase) is that the acquired Wi-Fi hotspot location deviates relative to the actual location of the positioning request.

More specifically, according to the exemplary embodiment of the present invention in which the positioning signal of the positioning request is the Wi-Fi positioning signal, a specific step of determining, by the apparatus, that the reason why the acquired location information is the bad positioning result (that is, Badcase) is that the acquired Wi-Fi hotspot location deviates relative to the actual location of the positioning request is: the apparatus obtains, from the Wi-Fi hotspot information database of the positioning service system, a confidence range of the Wi-Fi hotspot location information corresponding to the Wi-Fi positioning signal of the positioning request; and if the actual location of the positioning request is within the acquired confidence range, determines that data of the acquired confidence range is correct, and determines that the reason why the acquired location information is the bad positioning result (that is, Badcase) is that a manner in which the Wi-Fi hotspot information database of the positioning service system creates the Wi-Fi hotspot location information corresponding to the Wi-Fi positioning signal of the positioning request is wrong; or if the actual location of the positioning request is not within the acquired confidence range, determines that data of the acquired confidence range is incorrect, and determines that the reason why the acquired location information is the bad positioning result (that is, Badcase) is that all location data of the Wi-Fi hotspot information database of the positioning service system is wrong.

It should be noted that the apparatus can implement any one of the foregoing two exemplary embodiments, or may implement a combination of the foregoing two exemplary embodiments.

Wi-Fi positioning information is used as an example below, to further describe a specific implementation process of the present invention:

Specific data content of the Wi-Fi positioning information is as follows:

mac1,rssi1|mac2;rssi2| . . .

The foregoing data indicates a mac address and corresponding signal strength rssi of each surrounding hotspot in the positioning request, and it indicates that Wi-Fi positioning information includes two fields: mac and rssi.

When positioning information of the positioning request is Wi-Fi positioning information, the apparatus obtains, by using the existing positioning service system, Wi-Fi hotspot location information (wifix, wifiy) corresponding to the Wi-Fi positioning information of the positioning request; determines a distance between the obtained Wi-Fi hotspot location information (wifix, wifiy) and the actual location of the positioning request (gps_x, gps_y); and if the determined distance is not long or is very short, it indicates that the obtained Wi-Fi hotspot location does not deviate relative to the actual location of the positioning request, and that the reason why the acquired location information is the bad positioning result (that is, Badcase) is that a manner in which the positioning service system determines, according to obtained Wi-Fi hotspot location information, the Wi-Fi hotspot location information corresponding to the Wi-Fi positioning signal of the positioning request is problematic; or if the determined distance is very long, it indicates that the obtained Wi-Fi hotspot location deviates relative to the actual location of the positioning request, and that the reason why the acquired location information is the bad positioning result (that is, Badcase) is that the obtained Wi-Fi hotspot location deviates relative to the actual location of the positioning request.

To further determine impact inflicted by the deviation on the existing positioning service system, the apparatus may continue to obtain, from the Wi-Fi hotspot information database of the positioning service system, a confidence range (wifix, wifiy, wifi_radius) of the Wi-Fi hotspot location information corresponding to the Wi-Fi positioning signal of the positioning request; and if the actual location of the positioning request (gps_x, gps_y) is within the acquired confidence range, it indicates that the reason why the acquired location information is the bad positioning result (that is, Badcase) is that a manner in which the Wi-Fi hotspot information database of the positioning service system creates the Wi-Fi hotspot location information corresponding to the Wi-Fi positioning signal of the positioning request is problematic; or if the actual location of the positioning request (gps_x, gps_y) is not within the acquired confidence range, it indicates that the reason why the acquired location information is the bad positioning result (that is, Badcase) is that entire data of the Wi-Fi hotspot information database of the positioning service system is wrong.

If a base-station positioning policy is used, a request carries base-station information (cellID), if a Wi-Fi positioning policy is used, a request carries Wi-Fi information (mac, rssi), and if a request carries both base-station information and Wi-Fi information, a Wi-Fi positioning policy that combines both information is usually used for a positioning service.

FIG. 2 is a structural block diagram of a preferred embodiment of a positioning detection apparatus according to the present invention.

Referring to FIG. 2, the apparatus includes at least a positioning request acquiring unit 201, an original positioning service unit 202, a bad positioning unit 203, a result comparison unit 204, and a bad positioning determining unit 205.

The positioning request acquiring unit 201 is configured to acquire a positioning signal of any positioning request.

The original positioning service unit 202 is configured to obtain, by using an existing positioning service system, location information corresponding to the positioning signal of the positioning request.

The bad positioning unit 203 is configured to obtain, from a preset bad positioning result (that is, Badcase) database, location information of a bad positioning result (that is, Badcase) corresponding to the positioning signal of the positioning request, where the bad positioning result (that is, Badcase) database is used to store the positioning signal of the positioning request, and the location information of the bad positioning result (that is, Badcase) corresponding to the positioning signal of the positioning request.

The result comparison unit 204 is configured to determine whether the obtained location information is close to the obtained location information of the bad positioning result (that is, Badcase).

The bad positioning determining unit 205 is configured to: if the obtained location information is close to the obtained location information of the bad positioning result (that is, Badcase), determine that the obtained location information is the bad positioning result (that is, Badcase).

Because a user constantly generates a new positioning request everyday, a bad positioning result (that is, Badcase) further needs to be mined from newly added log data of the user, so that the bad positioning result (that is, Badcase) database can accurately reflect a newly added bad positioning result (that is, Badcase) of the positioning service system in time. According to an optional embodiment of the present invention, in the embodiment shown in FIG. 2, the apparatus further includes: a bad positioning update unit, configured to update the bad positioning result (that is, Badcase) database before obtaining, from the preset bad positioning result (that is, Badcase) database, the location information of the bad positioning result (that is, Badcase) corresponding to the positioning signal of the positioning request.

According to an exemplary embodiment of the present invention, the bad positioning update unit includes: a bad positioning mining subunit (not shown in the figure), configured to mine a bad positioning result (that is, Badcase) from a positioning log generated by the positioning service system; and a bad positioning update subunit (not shown in the figure), configured to update the bad positioning result (that is, Badcase) database according to the mined bad positioning result (that is, Badcase).

The actual location of the positioning request may be already known, or may be acquired by using GPS information carried in a positioning request of a mobile phone, which is not limited in the present invention.

In addition, it should be further noted that the foregoing manner of updating the bad positioning result (that is, Badcase) database is only for exemplary purpose, the present invention is not limited thereto, and all other manners may be applied to the present invention as long as these manners help to obtain latest data of a bad positioning result (that is, Badcase).

To provide a reasonable and reliable basis for repairing the positioning service system, according to another optional embodiment of the present invention, in the embodiment shown in FIG. 2, the apparatus further includes: a bad positioning analyzing unit (not shown in the figure), configured to determine a reason why the acquired location information is the bad positioning result (that is, Badcase).

Specifically, according to an exemplary embodiment of the present invention in which the positioning signal of the positioning request is a base-station positioning signal, the bad positioning analyzing unit includes: a base-station information acquiring subunit, configured to obtain, from a base-station information database of the positioning service system, base-station location information corresponding to the base-station positioning signal of the positioning request; a first distance determining subunit, configured to determine a distance between an acquired base-station location and an actual location of the positioning request; and a first analyzing subunit, configured to: if the determined distance is less than a first preset distance, determine that the obtained base-station location does not deviate relative to the actual location of the positioning request, and determine that the reason why the obtained location information is the bad positioning result (that is, Badcase) is that a manner in which the positioning service system determines, according to acquired base-station location information, the base-station location information corresponding to the base-station positioning signal of the positioning request is wrong; or a second analyzing subunit, configured to: if the determined distance is not less than the first preset distance, determine that the obtained base-station location deviates relative to the actual location of the positioning request, and determine that the reason why the obtained location information is the bad positioning result (that is, Badcase) is that the base-station location obtained by the base-station information acquiring subunit deviates relative to the actual location of the positioning request.

More specifically, according to the exemplary embodiment of the present invention in which the positioning signal of the positioning request is the base-station positioning signal, the second analyzing subunit obtains, from the base-station information database of the positioning service system, a confidence range of the base-station location information corresponding to the base-station positioning signal of the positioning request; and if the actual location of the positioning request is within the acquired confidence range, determine that data of the acquired confidence range is correct, and determine that the reason why the acquired location information is the bad positioning result (that is, Badcase) is that a manner in which the base-station information database of the positioning service system creates the base-station location information corresponding to the base-station positioning signal of the positioning request is wrong; or if the actual location of the positioning request is not within the acquired confidence range, determine that data of the acquired confidence range is incorrect, and determine that the reason why the acquired location information is the bad positioning result (that is, Badcase) is that all location data of the base-station information database of the positioning service system is wrong.

Specifically, according to an exemplary embodiment of the present invention in which the positioning signal of the positioning request is a Wi-Fi positioning signal, the bad positioning analyzing unit includes: a Wi-Fi information acquiring subunit, configured to obtain, from a base-station information database of the positioning service system, Wi-Fi hotspot location information corresponding to the Wi-Fi positioning signal of the positioning request; a second distance determining subunit, configured to determine a distance between an acquired Wi-Fi hotspot location and an actual location of the positioning request; and a third analyzing subunit, configured to: if the determined distance is less than a second preset distance, determine that the obtained Wi-Fi hotspot location does not deviate relative to the actual location of the positioning request, and determine that the reason why the obtained location information is the bad positioning result (that is, Badcase) is that a manner in which the positioning service system determines, according to acquired Wi-Fi hotspot location information, the Wi-Fi hotspot location information corresponding to the Wi-Fi positioning signal of the positioning request is wrong; or a fourth analyzing subunit, configured to: if the determined distance is not less than the second preset distance, determine that the obtained Wi-Fi hotspot location deviates relative to the actual location of the positioning request, and determine that the reason why the obtained location information is the bad positioning result (that is, Badcase) is that the obtained Wi-Fi hotspot location deviates relative to the actual location of the positioning request.

More specifically, according to the exemplary embodiment of the present invention in which the positioning signal of the positioning request is the Wi-Fi positioning signal, the fourth analyzing subunit obtains, from the Wi-Fi hotspot information database of the positioning service system, a confidence range of the Wi-Fi hotspot location information corresponding to the Wi-Fi positioning signal of the positioning request; and if the actual location of the positioning request is within the acquired confidence range, determine that data of the acquired confidence range is correct, and determine that the reason why the acquired location information is the bad positioning result (that is, Badcase) is that a manner in which the Wi-Fi hotspot information database of the positioning service system creates the Wi-Fi hotspot location information corresponding to the Wi-Fi positioning signal of the positioning request is wrong; or if the actual location of the positioning request is not within the acquired confidence range, determine that data of the acquired confidence range is incorrect, and determine that the reason why the acquired location information is the bad positioning result (that is, Badcase) is that all location data of the Wi-Fi hotspot information database of the positioning service system is wrong.

It should be noted that the apparatus can implement any one of the foregoing two exemplary embodiments, or may implement a combination of the foregoing two exemplary embodiments.

As can be seen, compared with the prior art, in the present invention, a bad positioning result (that is, Badcase) can be automatically detected in a positioning service process of a mobile phone, and moreover, a reason of the bad positioning result (that is, Badcase) can be determined. In addition, in the present invention, manual analyzing of a bad positioning result (that is, Badcase) is effectively avoided, which not only effectively improves detection and analyzing efficiency of a bad positioning result (that is, Badcase), but also implements online panoramic collection of a bad positioning result (that is, Badcase), thereby expanding estimation influence of a bad positioning result (that is, Badcase) in a positioning service process, and providing a reasonable and reliable basis for repairing a positioning service system.

It should be noted that according to an implementation requirement, each step described in this application may be divided into more steps, and two or more steps or some operations of a step may be combined into a new step, to achieve the objective of the present invention.

The method of the present invention may be implemented in hardware or firmware, or may be implemented as software or computer code that can be stored in a recording medium (such as a CD ROM, a RAM, a floppy disk, a hard disk, or a magneto-optical disk), or may be implemented as computer code that is downloaded by using a network, and that is originally stored in a remote recording medium or a non-temporary machine readable medium and that is to be stored in a local recording medium. Therefore, the method described herein may be processed by software stored in a recording medium that uses a general-purpose computer, a dedicated processor, or programmable or dedicated hardware (such as an ASIC or an FPGA). It may be understood that, a computer, a processor, a microprocessor controller, or programmable hardware includes a storage component (such as a RAM, a ROM, or a flash memory) that can store or receive software or computer code, and when the software or the computer code is accessed and executed by a computer, a processor, or hardware, the processing method described herein is implemented. Moreover, when a general-purpose computer accesses code used to implement the processing shown herein, as the code is executed, the general-purpose computer is converted to a dedicated computer configured to execute the processing shown herein.

Although the present invention is already described with reference to preferred embodiments, a person skilled in the art should understand that various modifications and variations may be made to these embodiments without departing from the spirit and scope of the present invention defined by the claims.

1. A positioning detection method, comprising:
acquiring a positioning signal of any positioning request;
obtaining, by using an existing positioning service system, location information corresponding to the positioning signal of the positioning request;
obtaining, from a preset bad positioning result database, location information of a bad positioning result corresponding to the positioning signal of the positioning request, wherein the bad positioning result database is used to store the positioning signal of the positioning request, and the location information of the bad positioning result corresponding to the positioning signal of the positioning request;
determining whether the location information corresponding to the positioning signal of the positioning request is close to the obtained location information of the bad positioning result; and
if the location information corresponding to the positioning signal of the positioning request is close to the obtained location information of the bad positioning result, determining that the location information corresponding to the positioning signal of the positioning request is the bad positioning result.

2. The method according to claim 1, before the obtaining, from a preset bad positioning result database, location information of a bad positioning result corresponding to the positioning signal of the positioning request, further comprises:
updating the bad positioning result database.

3. The method according to claim 2, wherein the updating the bad positioning result database comprises:
mining a bad positioning result from a positioning log generated by the positioning service system; and
updating the bad positioning result database according to the mined bad positioning result.

4. The method according to claim 1, further comprising:
determining a reason why the location information corresponding to the positioning signal of the positioning request is the bad positioning result.

5. The method according to claim 4, wherein the positioning signal of the positioning request is a base-station positioning signal; and
the determining a reason why the location information corresponding to the positioning signal of the positioning request is the bad positioning result comprises:
obtaining, from a base-station information database of the positioning service system, base-station location information corresponding to the base-station positioning signal of the positioning request;
determining a distance between an acquired base-station location and an actual location of the positioning request; and
if the determined distance is less than a first preset distance, determining that the acquired base-station location does not deviate relative to the actual location of the positioning request, and determining that the reason is that a manner in which the positioning service system determines, according to acquired base-station location information, the base-station location information corresponding to the base-station positioning signal of the positioning request is wrong; or
if the determined distance is not less than the first preset distance, determining that the acquired base-station location deviates relative to the actual location of the positioning request, and determining that the reason is that the acquired base-station location deviates relative to the actual location of the positioning request.

6. The method according to claim 5, wherein the determining that the reason is that the acquired base-station location deviates relative to the actual location of the positioning request comprises:
obtaining, from the base-station information database of the positioning service system, a confidence range of the base-station location information corresponding to the base-station positioning signal of the positioning request; and
if the actual location of the positioning request is within the acquired confidence range, determining that data of the acquired confidence range is correct, and determining that the reason therefor is that a manner in which the base-station information database of the positioning service system creates the base-station location information corresponding to the base-station positioning signal of the positioning request is wrong; or
if the actual location of the positioning request is not within the acquired confidence range, determining that data of the acquired confidence range is incorrect, and determining that the reason is that all location data of the base-station information database of the positioning service system is wrong.

7. The method according to claim 4, wherein the positioning signal of the positioning request is a Wi-Fi positioning signal; and
the determining a reason why the location information corresponding to the positioning signal of the positioning request is the bad positioning result comprises:
obtaining, from a Wi-Fi hotspot information database of the positioning service system, Wi-Fi hotspot location information corresponding to the Wi-Fi positioning signal of the positioning request;
determining a distance between an acquired Wi-Fi hotspot location and an actual location of the positioning request; and
if the determined distance is less than a second preset distance, determining that the acquired Wi-Fi hotspot location does not deviate relative to the actual location of the positioning request, and determining that the reason therefor is that a manner in which the positioning service system determines, according to acquired Wi-Fi hotspot location information, the Wi-Fi hotspot location information corresponding to the Wi-Fi positioning signal of the positioning request is wrong; or
if the determined distance is not less than second first preset distance, determining that the acquired Wi-Fi hotspot location deviates relative to the actual location of the positioning request, and determining that the reason therefor is that the acquired Wi-Fi hotspot location deviates relative to the actual location of the positioning request.

8. The method according to claim 7, wherein the determining that the reason therefor is that the acquired Wi-Fi hotspot location deviates relative to the actual location of the positioning request comprises:
obtaining, from the Wi-Fi hotspot information database of the positioning service system, a confidence range of the Wi-Fi hotspot location information corresponding to the Wi-Fi positioning signal of the positioning request; and
if the actual location of the positioning request is within the acquired confidence range, determining that data of the acquired confidence range is correct, and determining that the reason therefor is that a manner in which the Wi-Fi hotspot information database of the positioning service system creates the Wi-Fi hotspot location information corresponding to the Wi-Fi positioning signal of the positioning request is wrong; or
if the actual location of the positioning request is not within the acquired confidence range, determining that data of the acquired confidence range is incorrect, and determining that the reason therefor is that all location data of the Wi-Fi hotspot information database of the positioning service system is wrong.

9.-16. (canceled)

17. A computer storage medium, wherein the computer storage medium is coded with a computer program, and when the program is executed by one or more computers, the one or more computers perform the following operations:
acquiring a positioning signal of any positioning request;
obtaining, by using an existing positioning service system, location information corresponding to the positioning signal of the positioning request;
obtaining, from a preset bad positioning result database, location information of a bad positioning result corresponding to the positioning signal of the positioning request, wherein the bad positioning result database is used to store the positioning signal of the positioning request, and the location information of the bad positioning result corresponding to the positioning signal of the positioning request;
determining whether the location information corresponding to the positioning signal of the positioning request is close to the obtained location information of the bad positioning result; and
if the location information corresponding to the positioning signal of the positioning request is close to the obtained location information of the bad positioning result, determining that the location information corresponding to the positioning signal of the positioning request is the bad positioning result.

18. A device for positioning detection, comprising:
at least one processor; and
a memory storing instructions, which when executed by the at least one processor, cause the at least one processor to perform operations, the operations comprising:
obtaining, by using an existing positioning service system, location information corresponding to the positioning signal of the positioning request;
obtaining, from a preset bad positioning result database, location information of a bad positioning result corresponding to the positioning signal of the positioning request, wherein the bad positioning result database is used to store the positioning signal of the positioning request, and the location information of the bad positioning result corresponding to the positioning signal of the positioning request;
determining whether the location information corresponding to the positioning signal of the positioning request is close to the obtained location information of the bad positioning result; and
if the location information corresponding to the positioning signal of the positioning request is close to the obtained location information of the bad positioning result, determining that the location information corresponding to the positioning signal of the positioning request is the bad positioning result.

19. The device according to claim 18, before the operation of obtaining, from a preset bad positioning result database, location information of a bad positioning result corresponding to the positioning signal of the positioning request, further comprises:
updating the bad positioning result database.

20. The device according to claim 19, wherein the operation of updating the bad positioning result database comprises:
mining a bad positioning result from a positioning log generated by the positioning service system; and
updating the bad positioning result database according to the mined bad positioning result.

21. The device according to claim 18, the operations further comprising:
determining a reason why the location information corresponding to the positioning signal of the positioning request is the bad positioning result.

22. The device according to claim 21, wherein the positioning signal of the positioning request is a base-station positioning signal; and
the operation of determining a reason why the location information corresponding to the positioning signal of the positioning request is the bad positioning result comprises:
obtaining, from a base-station information database of the positioning service system, base-station location information corresponding to the base-station positioning signal of the positioning request;
determining a distance between an acquired base-station location and an actual location of the positioning request; and
if the determined distance is less than a first preset distance, determining that the acquired base-station location does not deviate relative to the actual location of the positioning request, and determining that the reason is that a manner in which the positioning service system determines, according to acquired base-station location information, the base-station location information corresponding to the base-station positioning signal of the positioning request is wrong; or
if the determined distance is not less than the first preset distance, determining that the acquired base-station location deviates relative to the actual location of the positioning request, and determining that the reason is that the acquired base-station location deviates relative to the actual location of the positioning request.

23. The device according to claim 22, wherein the operation of determining that the reason is that the acquired base-station location deviates relative to the actual location of the positioning request comprises:
obtaining, from the base-station information database of the positioning service system, a confidence range of the base-station location information corresponding to the base-station positioning signal of the positioning request; and
if the actual location of the positioning request is within the acquired confidence range, determining that data of the acquired confidence range is correct, and determining that the reason therefor is that a manner in which the base-station information database of the positioning service system creates the base-station location information corresponding to the base-station positioning signal of the positioning request is wrong; or
if the actual location of the positioning request is not within the acquired confidence range, determining that data of the acquired confidence range is incorrect, and determining that the reason is that all location data of the base-station information database of the positioning service system is wrong.

24. The device according to claim 21, wherein the positioning signal of the positioning request is a Wi-Fi positioning signal; and
the operation of determining a reason why the location information corresponding to the positioning signal of the positioning request is the bad positioning result comprises:
obtaining, from a Wi-Fi hotspot information database of the positioning service system, Wi-Fi hotspot location information corresponding to the Wi-Fi positioning signal of the positioning request;
determining a distance between an acquired Wi-Fi hotspot location and an actual location of the positioning request; and
if the determined distance is less than a second preset distance, determining that the acquired Wi-Fi hotspot location does not deviate relative to the actual location of the positioning request, and determining that the reason therefor is that a manner in which the positioning service system determines, according to acquired Wi-Fi hotspot location information, the Wi-Fi hotspot location information corresponding to the Wi-Fi positioning signal of the positioning request is wrong; or
if the determined distance is not less than second first preset distance, determining that the acquired Wi-Fi hotspot location deviates relative to the actual location of the positioning request, and determining that the reason therefor is that the acquired Wi-Fi hotspot location deviates relative to the actual location of the positioning request.

25. The device according to claim 24, wherein the operation of determining that the reason therefor is that the acquired Wi-Fi hotspot location deviates relative to the actual location of the positioning request comprises:
obtaining, from the Wi-Fi hotspot information database of the positioning service system, a confidence range of the Wi-Fi hotspot location information corresponding to the Wi-Fi positioning signal of the positioning request; and
if the actual location of the positioning request is within the acquired confidence range, determining that data of the acquired confidence range is correct, and determining that the reason therefor is that a manner in which the Wi-Fi hotspot information database of the positioning service system creates the Wi-Fi hotspot location information corresponding to the Wi-Fi positioning signal of the positioning request is wrong; or
if the actual location of the positioning request is not within the acquired confidence range, determining that data of the acquired confidence range is incorrect, and determining that the reason therefor is that all location data of the Wi-Fi hotspot information database of the positioning service system is wrong.
